(19) United States
(12) Patent Application Publication
(10) Pub. No.: US 2023/0222266 A1
(43) Pub. Date: Jul. 13, 2023

(54) EARTH-BORING TOOL STICK-SLIP PREDICTION SYSTEM AND RELATED METHODS

(71) Applicant: Baker Hughes Oilfield Operations LLC, Houston, TX (US)

(72) Inventors: Reed W. Spencer, Spring, TX (US); John A. Bomidi, Spring, TX (US); Xu Huang, Spring, TX (US); Oliver Matthews, III, Spring, TX (US)

(21) Appl. No.: 17/647,577

(22) Filed: Jan. 10, 2022

(51) Int. Cl. G06F 30/27; E21B 10/43

(52) U.S. Cl. CPC G06F 30/27; E21B 10/43; G06F 2111/10

(57) ABSTRACT

Methods and systems for receiving an earth-boring tool design, identifying a force model equation to utilize in simulating performance of the earth-boring tool design within a planned drilling operation, simulating performance of the earth-boring tool design within the planned drilling operation utilizing the identified force model equation, and based at least partially on the simulated performance of the earth-boring tool, estimating a probability of an actual earth-boring tool experiencing stick-slip within the planned drilling operation.

### TECHNICAL FIELD

This disclosure relates generally to earth-boring tool stick-slip prediction systems and methods of using such systems.

### BACKGROUND

Oil wells (wellbores) are usually drilled with a drill string. The drill string includes a tubular member having a drilling assembly that includes a single drill bit at its bottom end. The drilling assembly may also include devices and sensors that provide information pertaining to a variety of parameters relating to the drilling operations (“drilling parameters”), behavior of the drilling assembly (“drilling assembly parameters”) and parameters relating to the formations penetrated by the wellbore (“formation parameters”). A drill bit and/or reamer attached to the bottom end of the drilling assembly is rotated by rotating the drill string from the drilling rig and/or by a drilling motor (also referred to as a “mud motor”) in the bottom hole assembly (“BHA”) to remove formation material to drill the wellbore.

### BRIEF SUMMARY

Some embodiments of the present disclosure include a method of estimating a probability of an earth-boring tool experiencing stick-slip within a planned drilling operation. The method may include receiving an earth-boring tool design, identifying a force model equation to utilize in simulating performance of the earth-boring tool design within a planned drilling operation, simulating performance of the earth-boring tool design within the planned drilling operation utilizing the identified force model equation, and based at least partially on the simulated performance of the earth-boring tool, estimating a probability of an actual earth-boring tool experiencing stick-slip within the planned drilling operation.

In additional embodiments, the present disclosure includes an earth-boring tool system. The earth-boring tool system may include at least one processor and at least one non-transitory computer-readable storage medium storing instructions thereon that, when executed by the at least one processor, cause the prediction system to: receive an earth-boring tool design comprising computer model, identifying a force model equation to utilize in simulating operation of the earth-boring tool design within a planned drilling operation, simulating torque values relative to RPM values experienced the earth-boring tool design within the planned drilling operation utilizing the identified force model equation, and based at least partially on the simulated performance of the earth-boring tool, estimating a probability of an actual earth-boring tool experiencing stick-slip within the planned drilling operation.

Some embodiments of the present disclosure include a method of estimating a probability of an earth-boring tool experiencing stick-slip within a planned drilling operation. The method may include simulating performance of an earth-boring tool design for a range of RPM values utilizing a force model equation dependent on at least input RPM values, cutting element positions within the earth-boring tool design, and cutting tool face geometry, based on the estimated performance of the earth-boring tool design, simulating torque values experienced by the earth-boring tool design across a range of increasing RPM values, and based at least partially on the simulated torque values, estimating a probability of an actual earth-boring tool experiencing stick-slip within the planned drilling operation.

### BRIEF DESCRIPTION OF THE DRAWINGS

For a detailed understanding of the present disclosure, reference should be made to the following detailed description, taken in conjunction with the accompanying drawings, in which like elements have generally been designated with like numerals, and wherein:

FIG. 1 is a schematic diagram of a wellbore system comprising a drill string that includes an earth-boring tool according to one or more embodiments of the present disclosure;

FIG. 2 shows a flowchart of a method of determining a probability of an earth-boring tool experiencing stick-slip within a range of planned rotation-per-minute (RPM) values of a planned drilling operation according to one or more embodiments of the present disclosure;

FIG. 3 shows a flowchart of example processes for identifying a best force model equation for simulating performance an earth-boring tool design via a schematic-flow diagram according to one or more embodiments of the present disclosure;

FIGS. 4A and 4B depict graphs representing portions of simulated performances of various earth-boring tool designs in new and worn states utilizing the force model equations and methods;

FIG. 5 shows a flowchart of a method of adjusting an earth-boring tool design and/or a planned drilling operation according to one or more embodiments of the present disclosure; and

FIG. 6 is schematic diagram of a surface control unit of an embodiment of an earth-boring tool monitoring system of the present disclosure.

### DETAILED DESCRIPTION

The illustrations presented herein are not actual views of any drilling system, prediction system, or any component thereof, but are merely idealized representations, which are employed to describe embodiments of the present invention.

As used herein, the terms “bit” and “earth-boring tool” each mean and include earth-boring tools for forming, enlarging, or forming and enlarging a borehole. Non-limiting examples of bits include fixed-cutter (drag) bits, fixed-cutter coring bits, fixed-cutter eccentric bits, fixed-cutter bi-center bits, fixed-cutter reamers, expandable reamers with blades bearing fixed cutters, and hybrid bits including both fixed cutters and rotatable cutting structures (roller cones).

As used herein, the singular forms following “a,” “an,” and “the” are intended to include the plural forms as well, unless the context clearly indicates otherwise.

As used herein, the term “may” with respect to a material, structure, feature, or method act indicates that such is contemplated for use in implementation of an embodiment of the disclosure, and such term is used in preference to the more restrictive term “is” so as to avoid any implication that other compatible materials, structures, features, and methods usable in combination therewith should or must be excluded.

As used herein, the term “substantially” in reference to a given parameter, property, or condition means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” used in reference to a given parameter is inclusive of the stated value and has the meaning dictated by the context (e.g., it includes the degree of error associated with measurement of the given parameter, as well as variations resulting from manufacturing tolerances, etc.).

As used herein, the term “stick-slip” when used in reference to an earth-boring tool or a portion of an earth-boring tool refers to a portion of the earth-boring tool (e.g., a bit) stopping rotation or slowing down and then accelerating to speeds greater than a mean earth-boring tool (e.g., bottom hole assembly) rotational speed. For example, stick-slip action may be characterized by an absorption and release of energy as a function of a difference between static and dynamic friction. For instance, when stick-slip occurs at a bottom (e.g., an end) of a drill string, the stick-slip will include an accumulation and a release of energy stored as a portion of a turn or multiple turns of twist in the drill string.

Some embodiments of the present disclosure include a prediction system for determining how likely (e.g., a probability) that a given earth-boring tool design (e.g., bit design) will experience stick-slip while performing a drilling operation. For example, an operator may cause the prediction system to simulate operation of an earth-boring tool design (e.g., bit design) across a range of rotations-per-minute (RPM) values and to analyze resulting predicted torque values across the range of RPM values. Based on the predicted torque values, the prediction system may estimate the probability of an earth-boring tool represented by the earth-boring tool design experiencing stick-slip during the planned drilling operation. Furthermore, concern areas (e.g., portions) of the planned drilling operation may be identified where stick-slip is more likely. Based on the determined probability of experiencing stick-slip, an earth-boring tool design and/or the planned drilling operation may be adjusted.

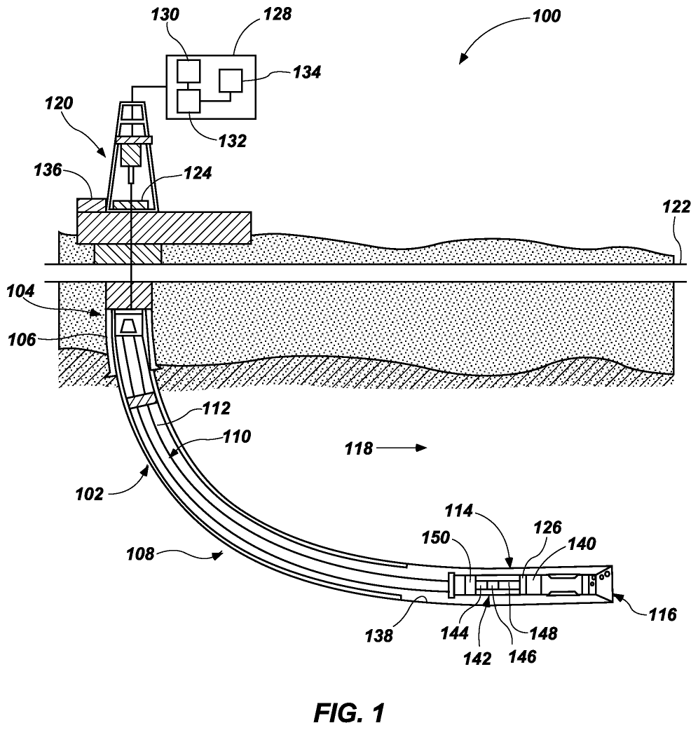

FIG. 1 is a schematic diagram of an example of a drilling system 100 that may utilize the apparatuses and methods disclosed herein for drilling boreholes. FIG. 1 shows a borehole 102 that includes an upper section 104 with a casing 106 installed therein and a lower section 108 that is being drilled with a drill string 110. The drill string 110 may include a tubular member 112 that carries a drilling assembly 114 at its bottom end. The tubular member 112 may be made up by joining drill pipe sections or it may be a string of coiled tubing. A drill bit 116 may be attached to the bottom end of the drilling assembly 114 for drilling the borehole 102 of a selected diameter in a formation 118.

The drill string 110 may extend to a rig 120 at the surface 122. The rig 120 shown is a land rig 120 for ease of explanation. However, the apparatuses and methods disclosed may also be used with an offshore rig 120 that is used for drilling boreholes under water. A rotary table 124 or a top drive may be coupled to the drill string 110 and may be utilized to rotate the drill string 110 and to rotate the drilling assembly 114, and thus the drill bit 116, to drill the borehole 102. A drilling motor 126 may be provided in the drilling assembly 114 to rotate the drill bit 116. The drilling motor 126 may be used alone to rotate the drill bit 116 or to superimpose the rotation of the drill bit 116 by the drill string 110. The rig 120 may also include conventional equipment, such as a mechanism to add additional sections to the tubular member 112 as the borehole 102 is drilled. A surface control unit 128, which may be a computer-based unit, may be placed at the surface 122 for receiving and processing downhole data transmitted by sensors 140 in the drill bit 116 and sensors 140 in the drilling assembly 114, and for controlling selected operations of the various devices and sensors 140 in the drilling assembly 114. The sensors 140 may include one or more of sensors 140 that determine acceleration, weight on bit, torque, pressure, cutting element positions, rate of penetration, inclination, azimuth, formation lithology, etc.

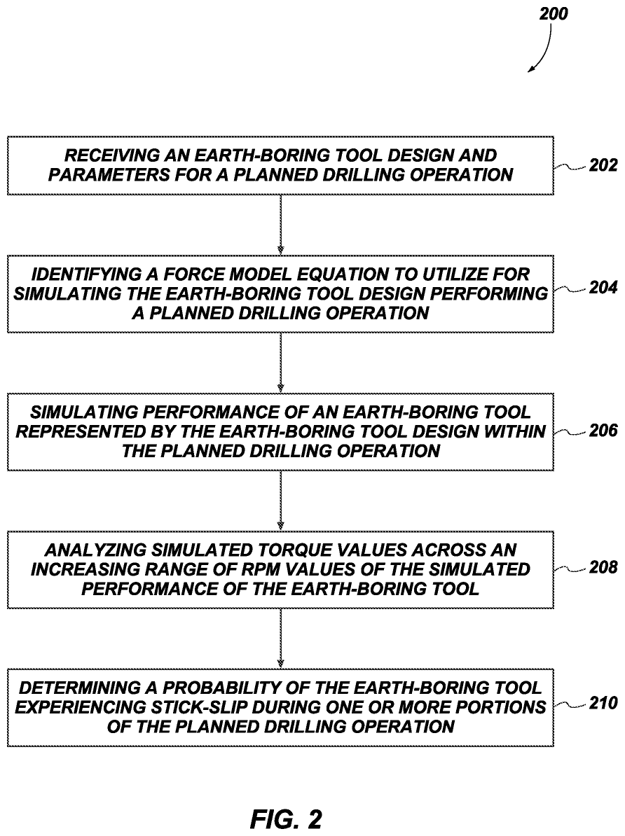

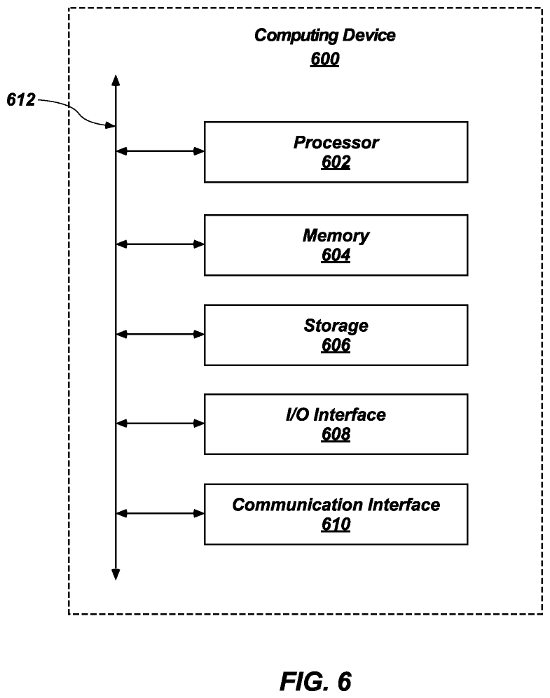

In some embodiments, the surface control unit 128 may include an earth-boring tool stick-slip prediction system 129 (also referred to here as “prediction system 129”). The prediction system 129 may include a processor 130 and a data storage device 132 (or a computer-readable medium) for storing data, algorithms, and computer programs 134. The data storage device 132 may be any suitable device, including, but not limited to, a read-only memory (ROM), a random-access memory (RAM), a flash memory, a magnetic tape, a hard disk, and an optical disc. Additionally, the surface control unit 128 may further include one or more devices for presenting output to an operator of the drilling assembly 114, including, but not limited to, a graphics engine, a display (e.g., a display screen), one or more output drivers (e.g., display drivers), one or more audio speakers, and one or more audio drivers. In certain embodiments, the surface control unit 128 is configured to provide graphical data to a display for presentation to an operator. The graphical data may be representative of one or more graphical user interfaces and/or any other graphical content as may serve a particular implementation. As is described in greater detail in regard to FIGS. 2-5, the prediction system 129 may generate predictive torque and RPM models (e.g., may predict torque values to be experienced by an earth-boring tool for planned RPM ranges of a planned drilling operation) based on lab testing data, field drilling data, one or more force model equations, and a given earth-boring tool design. Furthermore, although the prediction system 129 is described herein as being part of the surface control unit 128, the disclosure is not so limited; rather, as will be understood by one of ordinary skill in the art, the prediction system 129 may be discrete from the surface control unit 128 and may be disposed anywhere within the drilling assembly 114 or may be remote to the drilling assembly 114. In further embodiments, the prediction system 129 may be separate, remote, and discrete from the drilling system 100. The prediction system 129 is described in greater detail below with reference to FIG. 6.

During drilling, a drilling fluid from a source 136 thereof may be pumped under pressure through the tubular member 112, which discharges at the bottom of the drill bit 116 and returns to the surface 122 via an annular space (also referred as the “annulus”) between the drill string 110 and a sidewall 138 of the borehole 102.

The drilling assembly 114 may further include one or more downhole sensors 140 (collectively designated by numeral 140). The sensors 140 may include any number and type of sensors 140, including, but not limited to, sensors generally known as the measurement-while-drilling (MWD) sensors or the logging-while-drilling (LWD) sensors, and sensors 140 that provide information relating to the behavior of the drilling assembly 114, such as drill bit rotation (revolutions per minute or “RPM”), tool face, pressure, vibration, whirl, bending, and stick-slip. The drilling assembly 114 may further include a controller unit 142 that controls the operation of one or more devices and sensors 140 in the drilling assembly 114. For example, the controller unit 142 may be disposed within the drill bit 116 (e.g., within a shank and/or crown of a bit body of the drill bit 116). In some embodiments, the controller unit 142 may include, among other things, circuits to process the signals from sensor 140, a processor 144 (such as a microprocessor) to process the digitized signals, a data storage device 146 (such as a solid-state-memory), and a computer program 148. The processor 144 may process the digitized signals, and control downhole devices and sensors 140, and communicate data information with the surface control unit 128 and the prediction system 129 via a two-way telemetry unit 150.

FIG. 2 shows a flowchart of a method 200 of determining a probability of an earth-boring tool experiencing stick-slip within a range of planned RPM values of a planned drilling operation according to one or more embodiments of the present disclosure. The method 200 may be at least partially performed by the prediction system 129 described herein.

In some embodiments, the method 200 may include receiving an earth-boring tool design (e.g., a drill bit design) and parameters for a planned drilling operation, as shown in act 202 of FIG. 2. For example, the prediction system 129 may receive the earth-boring tool design and the parameters for the planned drilling operation. In some embodiments, the earth-boring tool design and/or the parameters for the planned drilling operation may be input from an operator (e.g., user). In additional embodiments, the earth-boring tool design and/or the parameters for the planned drilling operation may be received as one or more data packages from any other source (e.g., a third-party system, a server, an application, a mobile device, a database, a vendor, etc.).

In one or more embodiments, the earth-boring tool design may include a model (e.g., a numerical model, a computer model, a bit mechanics model) of a given actual, physical earth-boring tool (or an anticipated physical earth-boring tool). The model may include and represent dimensions, geometry (e.g., cutting element geometries of the earth-boring tool), mass distributions, material densities, material stiffnesses, and wear (e.g., new and dull cutting element geometries) state characterizations of the given earth-boring tool. For example, the model may define bit diameters, gage lengths, cutting element positions, cutting element wear states (e.g., versions), earth-boring tool types (e.g., hybrid bits, tri-cone bits, fixed-blade bits), bottom-hole assembly (“BHA”) options, etc.

In some embodiments, the parameters of the planned drilling operation may include drilling parameters and lithology parameters. The drilling parameters may include a desired and/or ranges of depth, RPM, turn rates, acceleration, WOB, pressure, rate of penetrations, lateral rate of penetrations, inclinations, azimuth, borehole trajectories, hole qualities, etc. In some embodiments, the lithology parameters may include rock types, rock strengths, grain/clast sizes, mineralogy, fabric, chemical properties, compositions, porosity, permeability, and/or texture of a subterranean formation to be drilled. As used herein, the term “drilling parameters” may refer to any of the drilling parameters and lithology parameters described herein. Additionally, the drilling parameters may include gamma ray levels, acoustic measurements, resistivity measurements, torque values, rib force, lateral bit force, etc. As a non-limiting example, the drilling parameters and earth-boring tool designs may include any of the parameters and earth-boring tool designs described in U.S. patent application Ser. No. 14/517,433, to Spencer et al., filed Oct. 17, 2014, the disclosure of which is incorporated in its entirety by reference herein.

Responsive to receiving the earth-boring tool design, the method 200 may include identifying a force model equation to utilize for at least partially simulating the earth-boring tool design performing a planned drilling operation, as shown in act 204 of FIG. 2. For example, the prediction system 129 may identify a best force model equation from a plurality of candidate force model equations. In some embodiments, the plurality of candidate force model equations may be predetermined and may be stored within database (e.g., a storage device). In one or more embodiments, the best force model equation may best minimizes losses during simulated performances of the earth-boring tool design. In some embodiments, the losses may include a combination of two factors. The first factor may include modeling errors using a force model equation (e.g., a difference between a model predicted bit ROP and a lab measured ROP). The second factor may include a number of terms in the force model equation. For instance, the more terms the force model equation has, the more losses the force model equation has because more terms will introduce overfitting problems and more parameters for calibration. In some embodiments, total losses can include either one of the two factors or both of the two factors. A total loss can be represented as Loss=k1*Func(Error_ROP, Error_wear, Error_drilling distance . . . )+k2*Func(# of equation terms).

In some embodiments, identifying the best force model equation for a given earth-boring tool design and a drilling operation may include identifying an equation such as the following Equation 1:

Total cutting force(Fₜₒₜₐₗ)=func(F_{static},∝ᵣₐₜₑ) Equation 1

Where

∝ᵣₐₜₑ=func(RPM,cutter position,rock type,cutting tool face geometry)

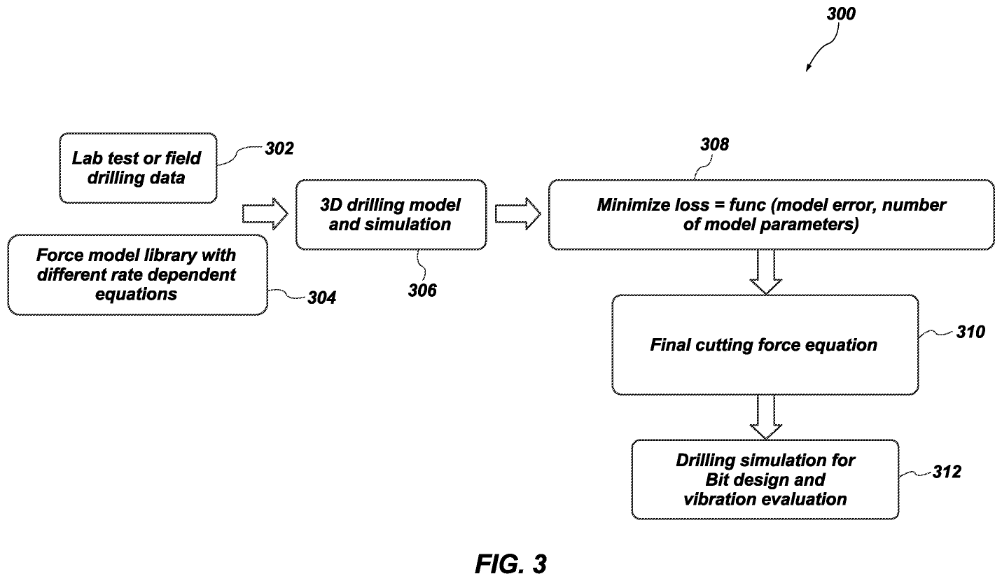

In some embodiments, the ∝ᵣₐₜₑ further depends on rake angles of the tool (e.g., an angle between a face normal vector and a velocity vectors), which assist in identifying sharp and/or worn faces. Identifying the best force model equation is described in greater detail below in regard to FIG. 3.

Upon identifying a best force model equation to utilize in simulating performance of the earth-boring tool design within a planned drilling operation, the method 200 may include simulating performance of an earth-boring tool represented by the earth-boring tool design within the planned drilling operation, as shown in act 206 of FIG. 2. For example, the prediction system 129 may simulate performance of the earth-boring tool within the planned drilling operation utilizing the identified force model equation. In some embodiments, the prediction system 129 may simulate performance of the earth-boring tool in a new state as well as one or more worn states.

In some embodiments, simulating performance of the earth-boring tool may include determining (e.g., calculate) one or more points of contact between the earth-boring tool and a wall of the borehole and forces experienced by the earth-boring tool at the one or more contact points and calculating forces experienced by the earth-boring tool at the one or more contact points. For example, the prediction system 129 may predict (e.g., estimate) axial and torsional friction to be experienced by an earth-boring tool during the planned drilling operation. Additionally, the prediction system 129 may predict (e.g., estimate) downhole torque values experienced by the earth-boring tool across a range of planned rotations-per-minute (RPM) values of the planned drilling operation. For instance, the prediction system 129 may utilize data, such as, surface data, data related to a well profile, a wellbore quality, adjustable kick off and stabilizers in the earth-boring tool, mud type, flow rates of hydraulic fluids, string rotations per minutes, buckling, and/or vibrations to predict axial and torsional friction (and torques) to be experienced by one or more portions of the earth-boring tool during the planned drilling operation. Additionally, the prediction system 129 may utilize the earth-boring tool design (e.g., the model) and the identified force model equation to determine and/or calculate in-situ rock strength, RPM values of the earth-boring tool in new and worn states, and/or ROP of the earth-boring tool in new and worn states. As a non-limiting example, the predictions system 129 may simulate performance of the earth-boring tool design via any of the methods described in U.S. Pat. No. 11,066,917, to Jain et al., issued Jul. 20, 2021, the disclosure of which is incorporated in its entirety by reference herein.

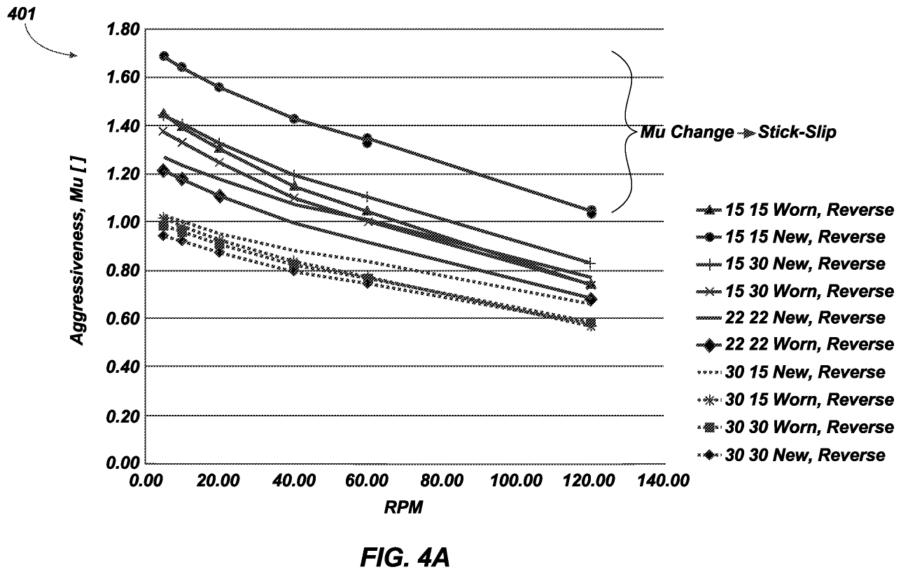

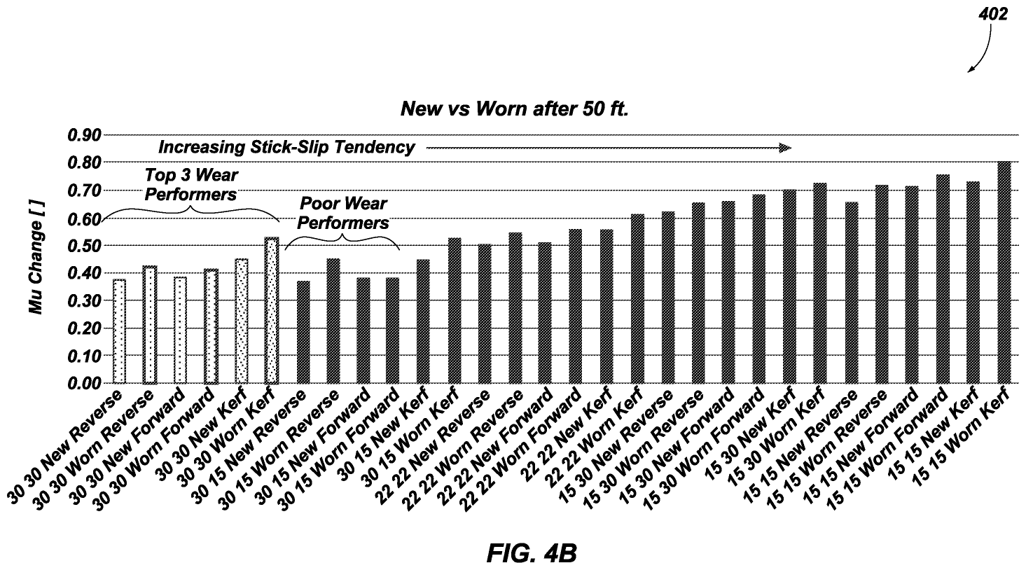

FIGS. 4A and 4B depict graphs 401, 402 representing portions of simulated performances of various earth-boring tool designs in new and worn states utilizing the force model equations and methods described herein. In particular, graphs 401, 402 depict simulated aggressiveness (Mu) values relative to simulated RPM (e.g., an expected range of RPM values for the planned drilling operation). The aggressiveness (Mu) values represent a simulated indention depth and torque values that occur for a simulated WOB. As shown in FIGS. 4A and 4B, various earth-boring tool designs were simulated in both new and worn states from about 5.0 RPM to about 120.0 RPM.

Referring to FIGS. 2, 4A, and 4B together, the method 200 may include analyzing the simulated torque values across an increasing range of RPM values of the simulated performance of the earth-boring tool, as shown in act 208 of FIG. 2. For example, the prediction system 129 may determine and analyze a change in the aggressiveness (Mu) values and/or a rate of change in the aggressiveness (Mu) values over the planned increasing range of RPM values for the planned drilling operation or one or more portions of the expected range of RPM values for the planned drilling operation.

Responsive to the determined change and/or rate of change in the aggressiveness (Mu) over the expected range of RPM or one or more portions of the planned increasing range of RPM values for the planned drilling operation, the method 200 may include determining a probability of the earth-boring tool experiencing stick-slip during one or more portions of the planned drilling operation, as shown in act 210 of FIG. 2. In particular, a decrease in the simulated aggressiveness (Mu) values over (e.g., across) an increasing range of RPM values indicates a greater probability (e.g., an increased probability) of experiencing stick-slip during the increasing range of RPM values and the planned drilling operation. Additionally, a simulated aggressiveness (Mu) values that remain substantially constant over (e.g., across) an increasing range of RPM values indicates a reduced probability (e.g., a decreased probability) of experiencing stick-slip during the increasing range of RPM values and the planned drilling operation. Furthermore, a higher rate of change in the aggressiveness (Mu) values (e.g., an ascending slope represented by the simulated aggressiveness (Mu) values) over the increasing range of RPM values (indicates a low probability of experiencing stick-slip during the increasing range of RPM values and the planned drilling operation. In some embodiments, the change in the aggressiveness (Mu) values per RPM has a generally linear relationship with the probability of experiencing stick-slip.

In some embodiments, determining a probability of the earth-boring tool experiencing stick-slip during one or more portions of the planned drilling operation may include identifying a range of planned RPM, ROP, or WOB values of the planned drilling operation most likely to cause stick-slip during the planned drilling operation. In other words, the prediction system 129 may include identifying a problematic range of planned RPM values for the planned drilling operation where the earth-boring tool is most likely to experience stick-slip.

In additional embodiments, determining a probability of the earth-boring tool experiencing stick-slip during one or more portions of the planned drilling operation may include identifying appropriate ranges of RPM values at which the earth-boring tool can operate without an elevated risk (e.g., probability) of experiencing stick-slip.

In some embodiments, the prediction system 129 may determine and output the determined probability of experiencing stick-slip within the one or more portions of the planned drilling operation as a percentage value or risk level value. For instance, the prediction system 129 may determine and output that an earth-boring tool represented by a given earth-boring tool design has a certain percent (e.g., 10%, 20%, 30%, 40%, 50%, or higher) chance of experiencing stick-slip within a planned range of RPM values or a planned drilling operation. In additional embodiments, the prediction system 129 may determine and output a risk level value (e.g., 1 through 5) that represents a probability of experiencing stick-slip within a planned range of RPM values or a planned drilling operation.

Referring still to FIG. 2, in some embodiments, the method 200 may include utilizing one or more machine learning techniques in determining a probability of experiencing stick-slip within a given range of RPM values or a drilling operation. For example, the method 200 may include utilizing one or more machine learning technique within any of the acts 206, 208, and 210 of FIG. 2.

In one or more embodiments, the machine learning techniques may include applying a regression analysis (e.g., a set of statistical processes for estimating the relationships among variables). Furthermore, as is known in the art, regression analysis may estimate conditional expectations of dependent variables (e.g., output variables) given independent variables (e.g., input variables). As a non-limiting example, the regression analysis may include a linear regression analysis. Moreover, as is known in the art, in a linear regression model, the output variables from the simulations (i.e., observations) are assumed to be the result of random deviations from an underlying relationship between (i.e., a predictive algorithm correlating) the dependent variables (y) and independent variables (x). In other words, the linear regression model may determine a relationship between the input parameters (i.e., input variables) described above and output variables from the simulations. As a result, via a regression analysis, the prediction system 129 may generate or assist in selecting a predictive algorithms that can be utilized to predict the output variables, and, as a result, generate simulations of drilling operations for a given earth-boring tool design.

In additional embodiments, the machine learning techniques may include a quadratic regression analysis, a logistic regression analysis, support vector machine, Gaussian process regression, ensemble methods, or any other regression analysis. Furthermore, in yet further embodiments, the machine learning techniques may include decision tree learning, regression trees, boosted trees, k-nearest neighbor, association rule learning, a neural network, deep learning, or any other type of machine learning. In yet further embodiments, the analysis may include a multivariate interpolation analysis.

As noted above, FIG. 3 shows a flowchart of example processes 300 for identifying a best force model equation for simulating performance an earth-boring tool design via a schematic-flow diagram. For instance, FIG. 3 shows one or more embodiments of a simplified sequence-flow that the prediction system 129 may utilize to identify a best force model equation to utilize for simulating performance an earth-boring tool design within a planned drilling operation.

As shown in FIG. 3, the processes 300 may include receiving lab test data and/or field drilling data, as shown in act 302 of FIG. 3. For example, the prediction system 129 may receive the lab test data and/or the field drilling data. In one or more embodiments, the lab test data and/or field drilling data may include historical offset well data. For example, the lab test data and/or field drilling data may include historical data including one or more of formation logs, well architecture and design data, surface and downhole data, past bit and cutting element design data, drilling system details data, and bit dull data.

Additionally, the processes 300 may include receiving a force model library having a plurality of different candidate rate dependent equations (i.e., force model equations), as shown in act 304 of FIG. 3. For example, the prediction system 129 may receive and/or query a force model library having the plurality of different candidate rate dependent equations. Each of the plurality of different candidate rate dependent equations may correlate in form to Equation 1 described above. Furthermore, in some embodiments, the processes 300 may include receiving rock type behavior repositories, cutting element type wear properties, and model parameters and uncertainties. Additionally, the processes 300 may include receiving three-dimensional geometry descriptions, rock failure models, cutting element wear progression models, cutting element fracture criteria, and any other phenomena that affect wear, torque, RPM, and ROP of earth-boring tools. In one or more embodiments, the force model library may further include pre-developed physics models that are based on historical data and/or theory and laboratory experimentation.

Responsive to receiving the lab test data and/or the field drilling data and the force model library, the processes 300 may include generating one or more three-dimensional drilling models and simulating performance of a given earth-boring tool design utilizing different candidate rate dependent equations, as shown in act 306 of FIG. 3. For instance, the prediction system 129 may generate one or more three-dimensional drilling models and may simulate performance of the given earth-boring tool design for the different candidate rate dependent equations of the force model library. The simulations may provide predictions (e.g., simulations, models, values, etc.) related to drilling parameters such as, (e.g., drilling operations that involve) for example, build-up-rates, turn rates, ROP, lateral ROP, RPM, unconfined compressive strength, walk rate, dog leg severity, confined compressive strength, contact forces, rib forces, bending moments, WOB, pressures, inclinations, azimuth, borehole trajectories, hole qualities, torque values, drilling vibrations, cutting element damage (e.g., breakage, chipping, cracking, spalling, etc.), bit trip, gage and bit body wear, etc. In further embodiments, the simulations may provide predictions (e.g., simulations, models, values, etc.) related to lithology parameters such as, (e.g., drilling operations that involve) for example, rock types, rock strengths, grain/clast sizes, mineralogy, fabric, chemical properties, compositions, porosity, permeability, and/or texture of a subterranean formation to be drilled. In some embodiments, one or more of the drilling parameters may be predetermined, and the remainder of the drilling parameters may be predicted based at least partially on the predetermined drilling parameters. Furthermore, performance of the earth-boring tool design may be simulated via any of the manners described above in regard to FIG. 2.

Responsive to generating one or more three-dimensional drilling models and simulating performance of the given earth-boring tool design for the different candidate rate dependent equations, the processes 300 may include identifying a rate dependent equation (i.e., force model equation) from the plurality of candidate rate dependent equations that best minimizes losses as a function of model errors and number of model parameters, as shown in act 308 of FIG. 3, and selecting the rate dependent equation as a final force model equation for simulating the given earth-boring tool design in the planned drilling operation, as shown in act 310 of FIG. 3. For example, the prediction system 129 may identify the best rate dependency equation for minimizing loss.

As discussed above, the processes 300 may further include simulating performance of the earth-boring tool design utilizing the final force model equation, as shown in act 312 of FIG. 3. For example, performance of the earth-boring tool design may be simulated via any of the manners described above in regard to FIG. 2. Moreover, as discussed above in regard to FIG. 2, based on the simulated performance of the earth-boring tool design, a probability that an earth-boring tool represented by the earth-boring tool design will experience stick-slip during a planned drilling operation may be determined.

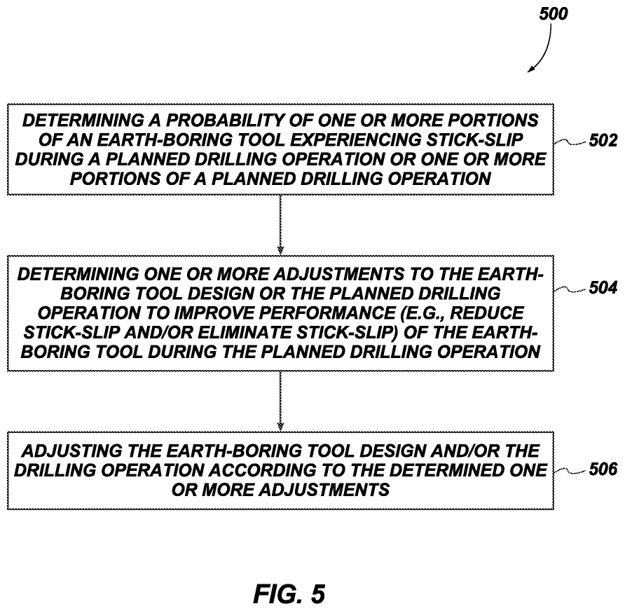

FIG. 5 shows a flowchart of a method 500 of adjusting an earth-boring tool design and/or a planned drilling operation according to one or more embodiments of the present disclosure. The method 500 may include determining a probability of one or more portions of an earth-boring tool experiencing stick-slip during the planned drilling operation or one or more portions of the planned drilling operation, as shown in act 502 of FIG. 5. For example, the predictions system 129 may determine the probability of one or more portions of an earth-boring tool experiencing stick-slip during the planned drilling operation or one or more portions of the planned drilling operation according to any the methods described above.

Based at least partially on the determined probability of the earth-boring tool design experiencing stick-slip during the planned drilling operation, the method 500 may include determining one or more adjustments to the earth-boring tool design or the planned drilling operation to improve performance (e.g., reduce stick-slip and/or eliminate stick-slip) of the earth-boring tool during the planned drilling operation, as shown in act 504 of FIG. 5. For example, the prediction system 129 may determine one or more adjustments to the earth-boring tool design or the planned drilling operation to improve performance (e.g., reduce stick-slip and/or eliminate stick-slip) of the earth-boring tool during the planned drilling operation. For instance, the prediction system 129 may determine one or more adjustments to cutting element geometries (e.g., chamfers), cutting element orientations (e.g., back rakes), blade geometries, tool body geometries, cutting element materials, and/or tool body materials to improve performance (e.g., reduce stick-slip and/or eliminate stick-slip) of the earth-boring tool during the planned drilling operation. As another non-limiting example, the prediction system 129 may determine one or more adjustments to one or more drilling parameters (e.g., RPM, WOB, depth of cut, ROP, etc.) to improve performance (e.g., reduce stick-slip and/or eliminate stick-slip) of the earth-boring tool during the planned drilling operation. In some embodiments, the prediction system 129 may output the one or more adjustments via a display of the prediction system 129.

In some embodiments, the method 500 may optionally further include adjusting the earth-boring tool design and/or the drilling operation according to the determined one or more adjustments, as shown in act 506 of FIG. 5. For example, the prediction system 129 may adjust one or more design parameters of the earth-boring tool design (e.g., make changes to a data package representing the earth-boring tool design). As an additional example, the prediction system 129 may adjust one or more drilling parameters of the planned drilling operation. In some embodiments, the adjustments of the earth-boring tool design and/or the planned drilling operation may be made in real time. For instance, during an actual drilling procedure, based on simulations of an earth-boring tool design representing an actual earth-boring tool, adjustments may be made to drilling parameters to improve performance (e.g., reduce stick-slip and/or eliminate stick-slip) of the earth-boring tool during the drilling operation.

Referring to FIGS. 1-5 together, the methods and systems from estimating a likelihood of an earth-boring tool experiencing stick-slip during a planned drilling operation may provide advantages over conventional drilling systems. For example, reducing and/or eliminating stick-slip in drilling operations may improve efficiency and longevity of an associated earth-boring tool by reducing wear and improving ROP while drilling. As a result, the methods and systems may improve cost savings and optimize earth-boring tool designs for given planned drilling operations.

FIG. 6 is a block diagram of a surface control unit 128 and/or prediction system 129 according to one or more embodiments of the present disclosure. As shown in FIG. 6, in some embodiments, the surface control unit 128 and/or prediction system 129 may include an earth-boring tool monitoring system 600 (e.g., computing device). One will appreciate that one or more computing devices may implement the earth-boring tool monitoring system 600. The earth-boring tool monitoring system 600 can comprise a processor 602, a memory 604, a storage device 606, an I/O interface 608, and a communication interface 610, which may be communicatively coupled by way of a communication infrastructure 612. While an exemplary computing device is shown in FIG. 6, the components illustrated in FIG. 6 are not intended to be limiting. Additional or alternative components may be used in other embodiments. Furthermore, in certain embodiments, the computing device 600 can include fewer components than those shown in FIG. 6. Components of the computing device 600 shown in FIG. 6 will now be described in additional detail.

In one or more embodiments, the processor 602 includes hardware for executing instructions, such as those making up a computer program. As an example and not by way of limitation, to execute instructions, the processor 602 may retrieve (or fetch) the instructions from an internal register, an internal cache, the memory 604, or the storage device 606 and decode and execute them. In one or more embodiments, the processor 602 may include one or more internal caches for data, instructions, or addresses. As an example and not by way of limitation, the processor 602 may include one or more instruction caches, one or more data caches, and one or more translation lookaside buffers (TLBs). Instructions in the instruction caches may be copies of instructions in the memory 604 or the storage device 606.

The memory 604 may be used for storing data, metadata, and programs for execution by the processor(s). The memory 604 may include one or more of volatile and non-volatile memories, such as Random Access Memory (“RAM”), Read-Only Memory (“ROM”), a solid state disk (“SSD”), Flash memory, Phase Change Memory (“PCM”), or other types of data storage. The memory 604 may be internal or distributed memory.

The storage device 606 includes storage for storing data or instructions. As an example and not by way of limitation, storage device 606 can comprise a non-transitory storage medium described above. The storage device 606 may include a hard disk drive (HDD), a floppy disk drive, flash memory, an optical disc, a magneto-optical disc, magnetic tape, or a Universal Serial Bus (USB) drive or a combination of two or more of these. The storage device 606 may include removable or non-removable (or fixed) media, where appropriate. The storage device 606 may be internal or external to the computing device 600. In one or more embodiments, the storage device 606 is non-volatile, solid-state memory. In other embodiments, the storage device 606 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

The I/O interface 608 allows a user to provide input to, receive output from, and otherwise transfer data to and receive data from computing device 600. The I/O interface 608 may include a mouse, a keypad or a keyboard, a touch screen, a camera, an optical scanner, network interface, modem, other known I/O devices or a combination of such I/O interfaces. The I/O interface 608 may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 608 is configured to provide graphical data to a display for presentation to a user. The graphical data may be representative of one or more graphical user interfaces and/or any other graphical content as may serve a particular implementation.

The communication interface 610 can include hardware, software, or both. In any event, the communication interface 610 can provide one or more interfaces for communication (such as, for example, packet-based communication) between the computing device 600 and one or more other computing devices or networks. As an example and not by way of limitation, the communication interface 610 may include a network interface controller (NIC) or network adapter for communicating with an Ethernet or other wire-based network or a wireless MC (WNIC) or wireless adapter for communicating with a wireless network, such as a WI-FI.

Additionally or alternatively, the communication interface 610 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the communication interface 610 may facilitate communications with a wireless PAN (WPAN) (such as, for example, a BLUETOOTH® WPAN), a WI-FI network, a WI-MAX network, a cellular telephone network (such as, for example, a Global System for Mobile Communications (GSM) network), or other suitable wireless network or a combination thereof.

Additionally, the communication interface 610 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

The communication infrastructure 612 may include hardware, software, or both that couples components of the computing device 600 to each other. As an example and not by way of limitation, the communication infrastructure 612 may include an Accelerated Graphics Port (AGP) or other graphics bus, an Enhanced Industry Standard Architecture (EISA) bus, a front-side bus (FSB), a HYPERTRANSPORT™ (HT) interconnect, an Industry Standard Architecture (ISA) bus, an INFINIBAND™ interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

The embodiments of the disclosure described above and illustrated in the accompanying drawings do not limit the scope of the disclosure, which is encompassed by the scope of the appended claims and their legal equivalents. Any equivalent embodiments are within the scope of this disclosure. Indeed, various modifications of the disclosure, in addition to those shown and described herein, such as alternative useful combinations of the elements described, will become apparent to those skilled in the art from the description. Such modifications and embodiments also fall within the scope of the appended claims and equivalents.

What is claimed is:

1. A method, comprising:
identifying a force model equation to utilize in simulating performance of an earth-boring tool design within a planned drilling operation;
simulating performance of the earth-boring tool design within the planned drilling operation utilizing the identified force model equation; and
based at least partially on the simulated performance of an earth-boring tool according to the earth-boring tool design, estimating a probability of an actual earth-boring tool experiencing stick-slip within the planned drilling operation.

2. The method of claim 1, further comprising:
receiving lab test data and field drilling data; and
identifying the force model equation based at least partially on the received lab test data and field drilling data.

3. The method claim 1, wherein simulating performance of the earth-boring tool design within the planned drilling operation comprising simulating torque values to be experienced by one or more portions of the earth-boring tool for a range of expected RPM values of the planned drilling operation.

4. The method of claim 3, wherein estimating the probability of the actual earth-boring tool experiencing stick-slip within the planned drilling operation comprises analyzing a behavior of estimated torque values to be experienced by the one or more portions of the earth-boring tool as RPM values increase.

5. The method of claim 4, further comprising responsive to determining that the estimated torque values are predicted to decrease as RPM value increase, determining that the actual earth-boring tool has an increased probability of experiencing stick-slip within the planned drilling operation.

6. The method of claim 4, further comprising responsive to determining that the estimated torque values are predicted to remain substantially constant as RPM value increase, determining that the actual earth-boring tool has a decreased probability of experiencing stick-slip within the planned drilling operation.

7. The method of claim 1, wherein identifying the force model equation comprises selecting the force model equation from a plurality of candidate force model equations based at least partially on one or more simulations of performance of the earth-boring tool design within the planned drilling operation.

8. The method of claim 7, wherein the identified force model equation comprises:
Total cutting force(Fₜₒₜₐₗ)=func(F_{static},∝ᵣₐₜₑ).

9. The method of claim 7, wherein identifying the force model equation comprises identifying a force model equation from the plurality of candidate force model equations that best minimizes losses.

10. The method of claim 1, wherein simulating performance of the earth-boring tool design within the planned drilling operation comprises simulating performance of the earth-boring tool design via one or more machine learning techniques.

11. The method of claim 1, further comprising determining one or more adjustments to one or more of the earth-boring tool design and the planned drilling operation to reduce the probability that the earth-boring tool will experience stick-slip within the planned drilling operation.

12. The method of claim 11, wherein the one or more adjustments comprises one or more of an adjustment to a chamfer geometry of one or more cutting elements of the earth-boring tool, a change to a back rake of one or more cutting elements of the earth-boring tool, and a change to position of one or more cutting elements of the earth boring tool.

13. The method of claim 11, wherein the one or more adjustments comprises a change to a planned RPM range of the planned drilling operation.

14. The method of claim 1, further comprising outputting the estimated probability of the actual earth-boring tool experiencing stick-slip within the planned drilling operation as a percentage value.

15. An earth-boring tool performance prediction system, comprising:
at least one processor; and
at least one non-transitory computer-readable storage medium storing instructions thereon that, when executed by the at least one processor, cause the prediction system to:
receive an earth-boring tool design comprising a computer model;
identify a force model equation to utilize in simulating operation of the earth-boring tool design within a planned drilling operation;
simulate torque values relative to RPM values experienced by the earth-boring tool design within the planned drilling operation utilizing the identified force model equation; and
based at least partially on the simulated torque values, estimate a probability of an actual earth-boring tool experiencing stick-slip within the planned drilling operation.

16. The prediction system of claim 15, wherein the identified force model equation is dependent on input RPM values, cutting element geometries and positions within the earth-boring tool design, and cutting tool face geometry.

17. The prediction system of claim 15, wherein the earth-boring tool design comprises dimensions of an earth-boring tool, cutting element geometries and positions of the earth-boring tool, and new and dull versions of the earth-boring tool.

18. The prediction system of claim 15, further comprising instructions that, when executed by the at least one processor, cause the prediction system to determine one or more adjustments to one or more of the earth-boring tool design and the planned drilling operation to reduce the probability that the earth-boring tool will experience stick-slip within the planned drilling operation.

19. The prediction system of claim 18, wherein the one or more adjustments comprises one or more of an adjustment to a chamfer geometry of one or more cutting elements of the earth-boring tool, a change to a back rake of one or more cutting elements of the earth-boring tool, a change to a position of one or more cutting elements of the earth-boring tool and a change to a planned RPM range of the planned drilling operation.

20. A method, comprising:
simulating performance of an earth-boring tool design for a range of RPM values within a planned drilling operation utilizing a force model equation dependent on at least input RPM values, cutting element positions within the earth-boring tool design, and cutting tool face geometry;
based on the simulated performance of the earth-boring tool design, simulating torque values experienced by the earth-boring tool design across a range of increasing RPM values; and
based at least partially on the simulated torque values, estimating a probability of an actual earth-boring tool experiencing stick-slip within the planned drilling operation.
